(19) United States
(12) Patent Application Publication
(10) Pub. No.: US 2024/0208814 A1
(43) Pub. Date: Jun. 27, 2024

(54) PROCESS FOR PREPARING CHLORINE

(71) Applicant: BASF SE, Ludwigshafen am Rhein (DE)

(72) Inventors: Gerhard OLBERT, Ludwigshafen am Rhein (DE); Hans SCHUYTEN, Antwerp (BE); Torsten MATTKE, Ludwigshafen am Rhein (DE)

(21) Appl. No.: 18/287,492

(22) PCT Filed: Mar. 14, 2022
(86) PCT No.: PCT/EP2022/056535

§ 371 Date: Oct. 19, 2023

(30) Foreign Application Priority Data
Apr. 21, 2021 (EP) 21169636.4

(51) Int. Cl. C01B 7/04; B01J 10/00; B01J 23/46; C01B 7/07; C01B 32/80

(52) U.S. Cl. CPC C01B 7/04; B01J 10/007; B01J 23/462; C01B 7/0743; C01B 32/80

(57) ABSTRACT

The present invention relates to a continuous process for preparing chlorine and a production unit for carrying out said process. The present invention further relates to a use of said production unit for the continuous production of chlorine.

The present invention relates to a continuous process for preparing chlorine and a production unit for carrying out said process. The present invention further relates to a use of said production unit for the continuous production of chlorine.

In the large-scale production of isocyanates by phosgenation of the corresponding amines, large amounts of HCl are obtained as a by-product. In addition to its use in other applications, the recovery of chlorine from the HCl and its use in phosgene synthesis is an attractive route (chlorine recycling).

Electrochemical processes are expensive both in terms of investment and operating costs. The oxidation of HCl to chlorine, the so-called Deacon process, is more economically attractive. The Cl₂ produced can then be used to manufacture other commercially valuable products, such as phosgene and isocyanates from phosgene, and at the same time the emission of waste hydro-chloric acid is curtailed. The Deacon process is based on the gas phase oxidation of hydrogen chloride. HCl is reacted with oxygen over a catalyst, for example copper chloride (CuCl₂), Ru-based catalyst or Ce-based catalyst as disclosed in WO2007/134771 A1, WO2011/111351 A1, WO2013/004651 A1, WO 2013/060628 A1 and U.S. Pat. No. 2,418,930 A, to form chlorine and water in the gas phase at temperatures of 200 to 500° C. It is an equilibrium reaction with a slight exotherm. Cooled reactors are used to control the temperature development and avoid hot spots. Both tube-bundle reactors and fluidized beds are known.

To avoid corrosion damage, suitable materials are required that can withstand the aggressive substance system at high temperatures, including nickel and nickel-based alloys but also silicon carbide. These materials and their processing is comparatively expensive, which leads to correspondingly high costs for the reactor. In addition, a high-temperature cooling system is required, which causes additional costs. As a rule, a nitrate/nitrite molten salt is used as the cooling system. In the event of a leak, this can react with the reaction gas and damage the reactor. Therefore, there is a need to provide a new process for preparing chlorine which permits to avoid these problems.

Thus, the object of the present invention is to provide a new process for preparing chlorine which permits to improve the production of chlorine and avoid the problems of the prior art, such as deterioration of the production unit used for such processes, leakage of the cooling systems, as well as the deterioration/destruction of the used catalyst.

Surprisingly, it was found that the process for preparing chlorine according to the present invention permits to provide chlorine at an improved conversion rate and to avoid the deterioration of the reactor. Thus, the process according to the present invention may be used for a longer period by reducing the need for changing deactivated catalysts. Further, leakage of the cooling system is also avoided in the reactor. Hence the process of the present invention is effective and permits to reduce production costs.

Therefore, the present invention relates to a continuous process for preparing chlorine, comprising
(i) providing a gas stream G1 comprising oxygen (O₂) and hydrogen chloride (HCl);
(ii) passing the gas stream G1 into a reaction zone Z, bringing the gas stream G1 into contact with a catalyst comprised in said reaction zone Z, obtaining a gas stream GP comprising chlorine (Cl₂) and one or more of O₂, H₂O and HCl, and removing the gas stream GP from said reaction zone Z;
(iii) dividing the gas stream GP, obtaining at least two gas streams comprising a gas stream G2 and a gas stream GR, G2 and GR having the same chemical composition as GP, wherein the ratio of the mass flow f(GR) of the gas stream GR relative to the mass flow f(G2) of the gas stream G2, f(GR):f(G2), is in the range of from 0.1:1 to 20:1;
   wherein during standard operation mode of the continuous process, providing the gas stream G1 according to (i) comprises
   preparing G1 as a mixture comprising at least two gas streams, said at least two gas streams comprising the gas stream GR and j gas streams G0(k) with k=1, . . . j, wherein the j gas streams G0(k) in total comprise oxygen (O₂) and hydrogen chloride (HCl) and
   wherein j is in the range of from 1 to 3.

Preferably j is 1 or 2, more preferably j is 2.

Preferably the mixture consists of the at least two gas streams.

As to the reaction zone Z, it is preferred that it is an adiabatic reaction zone. This means that the reaction zone is operated adiabatically.

Preferably f(GR):f(G2) is in the range of from 1:1 to 10:1, more preferably in the range of from 2:1 to 8:1, more preferably in the range of from 2.5:1 to 6:1, more preferably in the range of from 3:1 to 5:1, more preferably in the range of from 3.2:1 to 5:1, more preferably in the range of from 3.4:1 to 5:1.

As to the amount of oxygen and hydrochloric acid in the j gas streams G0(k) used for the process of the present invention, there is no particular restrictions as far as enough chlorine is produced by said process. However, it is preferred that the mole ratio of the amount of oxygen, in mol, to the amount of hydrogen chloride, in mol, in the j gas streams G0(k) is in the range of from 0.1:1 to 2:1, more preferably in the range of 0.15:1 to 0.8:1, more preferably in the range of from 0.2:1 to 0.7:1, more preferably in the range of from 0.3:1 to 0.6:1.

During standard operation mode of the continuous process, it is preferred according to a first aspect of the present invention that providing the gas stream G1 according to (i) comprises preparing G1 as a mixture comprising, more preferably consisting of, three gas streams, said three gas streams comprising the gas stream GR and two gas streams G0(1) and G0(2), wherein the two gas streams G0(1) and G0(2) in total comprise oxygen (O₂) and hydrogen chloride (HCl).

During standard operation mode of the continuous process, it is preferred according to said first aspect that providing the gas stream G1 according to (i) comprises preparing G1, as a mixture comprising, more preferably consisting of, three gas streams GR, G0(1) and G0(2), G0(1) comprising oxygen (O₂) and G0(2) comprises hydrogen chloride (HCl), which comprises
combining the gas stream G0(1) with the gas stream G0(2), more preferably in a static mixer, and
admixing the gas stream GR with the combined gas streams G0(1) and G0(2).

According to said first aspect, it is preferred that admixing the gas stream GR with the combined two gas streams G0(1) and G0(2) according to (i) is performed in a mixing device, wherein the mixing device is an ejector, a static mixer or a dynamic mixer, more preferably an ejector, wherein the ejector is more preferably driven by the combined gas streams G0(1) and G0(2). It is noted in this respect, that when a static mixer or a dynamic mixer is used for admixing GR with the combined gas streams G0(1) and G0(2), a compressor is preferably used for compressing GR prior to entering into the mixer.

According to said first aspect, it is preferred that the combined gas streams G0(1) and G0(2) have a pressure P0 and the gas stream GR has a pressure PR, wherein P0>PR. It is preferred that the gas stream G1 has a pressure P1 and that P0≥P1>PR. As to the pressure P0 in bar(abs), there is no particular restrictions as it will depend on the flow set-up in a production unit. It is however preferred that it ranges from 2 to 50 bar(abs), more preferably from 4 to 20 bar(abs).

According to said first aspect, it is preferred that the mole ratio of the amount of oxygen, in mol, to the amount of hydrogen chloride, in mol, in the combined gas streams G0(1) and G0(2) is in the range of from 0.1:1 to 2:1, more preferably in the range of 0.15:1 to 0.8:1, more preferably in the range of from 0.2:1 to 0.7:1, more preferably in the range of from 0.3:1 to 0.6:1. The following preferred features are according to the present invention and to any aspects of this invention.

In the context of the present invention, it is preferred that the recycle ratio is the ratio of the mass flow f(GR) of the gas stream GR relative to the mass flow f(GP) of the gas stream GP, f(GR):f(GP), which is in the range of from 0.2:1 to 0.95:1, more preferably in the range of from 0.5:1 to 0.9:1, more preferably in the range of from 0.7:1 to 0.85:1.

It is preferred that the gas stream GP has a temperature T(GP) of at most 450° C., more preferably of at most 400° C., wherein said temperature T(GP) is more preferably controlled by fixing the recycle ratio defined in the foregoing and by varying the temperature of the gas stream G1. Indeed, it is preferred that the amount and the temperature of the recycle gas, namely gas stream GR, are selected to control the outlet temperature of the reaction zone which corresponds to the temperature of the gas stream GP, to a temperature of at most 450° C., more preferably of at most 400° C.

It is preferred that the gas stream G1 has a temperature T(G1) of at least 200° C., more preferably at least 250° C., more preferably in the range of from 250° C. to 300° C.

As to (ii), it is preferred that it further comprises passing the gas stream GP removed from the reaction zone Z in a heat exchanger, obtaining a cooled gas stream GP, more preferably having a temperature in the range of from 200 to 350° C., more preferably in the range of from 250 to 300° C. Preferably the heat exchanger is a tube bundle heat exchanger. It is conceivable that said heat exchanger preferably comprises a catalyst, such as the catalyst used in (ii).

Therefore, the present invention preferably relates to a continuous process for preparing chlorine, comprising
(i) providing a gas stream G1 comprising oxygen (O₂) and hydrogen chloride (HCl);
(ii) passing the gas stream G1 into a reaction zone Z, bringing the gas stream G1 into contact with a catalyst comprised in said reaction zone Z, obtaining a gas stream GP comprising chlorine (Cl₂) and one or more of O₂, H₂O and HCl, removing the gas stream GP from said reaction zone Z, passing the gas stream GP removed from the reaction zone Z in a heat exchanger, obtaining a cooled gas stream GP, more preferably having a temperature in the range of from 200 to 350° C., more preferably in the range of from 250 to 300° C.;
(iii) dividing the gas stream GP obtained according to (ii), obtaining at least two gas streams comprising a gas stream G2 and a gas stream GR, G2 and GR having the same chemical composition as GP, wherein the ratio of the mass flow f(GR) of the gas stream GR relative to the mass flow f(G2) of the gas stream G2, f(GR):f(G2), is in the range of from 0.1:1 to 20:1, more preferably in the range of from 1:1 to 10:1, more preferably in the range of from 3.2:1 to 5:1, more preferably in the range of from 3.4:1 to 5:1;
wherein during standard operation mode of the continuous process, providing the gas stream G1 according to (i) comprises
preparing G1 as a mixture comprising at least two gas streams, said at least two gas streams comprising the gas stream GR and j gas streams G0(k) with k=1, . . . j, wherein the j gas streams G0(k) in total comprise oxygen (O₂) and hydrogen chloride (HCl) and wherein j is in the range of from 1 to 3, more preferably j is 2.

In the context of the present invention, it is preferred that (iii) further comprises passing the gas stream GR in a heat exchanger, obtaining a cooled gas stream GR, more preferably having a temperature in the range of from 200 to 350° C., more preferably in the range of from 250 to 300° C., prior to admixing with G0 in (i.2) during standard operation mode of the continuous process. Preferably the heat exchanger is a tube bundle heat exchanger.

It is more preferred that (iii) further comprises
passing the gas stream G2 in a heat exchanger, obtaining a cooled gas stream G2, preferably having a temperature in the range of from 200 to 350° C., more preferably in the range of from 250 to 300° C. It is noted that the preferred use of a heat exchanger for cooling GR is not necessary when the gas stream GP has been preferably cooled in (ii), but it can be also used in addition to the heat exchanger used in (ii). The heat exchanger for cooling GR is used alternatively to the heat exchanger used for GP in (ii) mentioned above. Same is true for the heat exchanger for cooling G2.

It is preferred that the gas stream G0(k) has a temperature T(G0(k)) in the range of from 20 to 350° C., preferably in the range of from 100 to 340° C., more preferably in the range of from 200 to 350° C., more preferably in the range of from 250 to 300° C.

It is preferred according to the first aspect of the present invention that the gas stream G0(1) has a temperature T(G0(1)) in the range of from 200 to 350° C., more preferably in the range of from 250 to 300° C., and the gas stream G0(2) has a temperature T(G0(2)) in the range of from 200 to 350° C., more preferably in the range of from 250 to 300° C.

It can also be conceivable according to the first aspect of the present invention that preparing G1, as a mixture comprising, more preferably consisting of, three gas streams GR, G0(1) and G0(2), G0(1) comprising oxygen (O₂) and G0(2) comprises hydrogen chloride (HCl), which comprises
admixing one of the gas stream G0(1) and the gas stream G0(2) with the gas stream GR, preferably in an ejector, more preferably an ejector driven by the gas stream G0(1) or G0(2);
adding the other of the gas stream G0(1) and the gas stream G0(2) to the admixed gas streams.

During standard operation mode of the continuous process, it is preferred according to a second aspect that providing the gas stream G1 according to (i) comprises preparing G1 as a mixture comprising, more preferably consisting of, a liquid stream L and three gas streams comprising the gas stream GR and two gas streams G0(1) and G0(2), wherein the two gas streams G0(1) and G0(2) in total comprise oxygen (O₂) and hydrogen chloride (HCl), wherein the liquid stream L comprises hydrogen chloride (HCl) and water.

During standard operation mode of the continuous process, it is preferred according to the second aspect that providing the gas stream G1 according to (i) comprises preparing G1, as a mixture comprising, more preferably consisting of, a liquid stream L and three gas streams GR, G0(1) and G0(2), G0(1) comprising oxygen (O₂) and G0(2) comprises hydrogen chloride (HCl), wherein the liquid stream L comprises hydrogen chloride (HCl) and water, which comprises
combining the gas stream G0(1) with the gas stream G0(2), more preferably in a static mixer, and
admixing the gas stream GR with the combined gas streams G0(1) and G0(2) and the liquid stream L.

Preferably admixing the gas stream GR with the combined two gas streams G0(1) and G0(2) and the liquid stream L according to (i) is performed in a mixing device, wherein the mixing device is an ejector, a static mixer or a dynamic mixer, more preferably an ejector. It is preferred that the ejector be driven by the combined gas streams G0(1) and G0(2).

During standard operation mode of the continuous process, it is alternatively preferred according to the second aspect that providing the gas stream G1 according to (i) comprises preparing G1, as a mixture comprising, more preferably consisting of, a liquid stream L and three gas streams GR, G0(1) and G0(2), G0(1) comprising oxygen (O₂) and G0(2) comprises hydrogen chloride (HCl), wherein the liquid stream L comprises hydrogen chloride (HCl) and water, which comprises
combining the gas stream G0(1) with the gas stream G0(2), more preferably in a static mixer,
admixing the gas stream GR with the combined gas streams G0(1) and G0(2), and
subsequently adding the liquid stream L to the admixed gas streams.

Preferably admixing the gas stream GR with the combined two gas streams G0(1) and G0(2) according to (i) is performed in a mixing device, wherein the mixing device is an ejector, a static mixer or a dynamic mixer, more preferably an ejector. It is preferred that the ejector be driven by the combined gas streams G0(1) and G0(2).

Preferably the liquid stream L has temperature T(L) in the range of from 10 to 60° C., more preferably in the range of from 15 to 30° C. It is preferred that the liquid stream L consists of HCl and water. In the context of the present invention, it is preferred that the pipes for transporting the liquid stream L are preferably made of silicon carbide (SIC).

Preferably from 10 to 60 weight-%, more preferably from 20 to 50 weight-%, more preferably from 20 to 40 weight-%, of the liquid stream L consists of HCl.

Preferably from 98 to 100 weight-%, more preferably from 99 to 100 weight-%, more preferably from 99.5 to 100 weight-%, of the liquid stream L consists of water and HCl. The following preferred features are according to the present invention and to any aspects of this invention.

It is preferred that during standard operation mode of the continuous process, providing G1 according to (i) further comprises passing the combined gas streams G0(1) and G0(2) in a heat exchanger, obtaining a cooled gas stream G0, more preferably having a temperature in the range of from 10 to 60° C., more preferably in the range of from 15 to 30° C.

In the context of the present invention, it is preferred that from 50 to 100 weight-%, more preferably from 70 to 100 weight-%, more preferably from 90 to 100 weight-%, more preferably from 99 to 100 weight-%, more preferably from 99.5 to 100 weight-%, of the j gas streams G0(k) consist of HCl and O₂. In other words, it is preferred that the j gas streams G0(k) consist essentially of, more preferably consist of, HCl and O₂. In the context of the present invention, it is conceivable that recycled stream(s), other than the gas stream GR, be added to the j gas stream G0(k) upstream of the reaction zone.

In the context of the present invention, it is preferred that according to (iii), two gas streams are obtained, a gas stream G2 and a gas stream GR. Therefore, the present invention preferably relates to a continuous process for preparing chlorine, comprising
(i) providing a gas stream G1 comprising oxygen (O₂) and hydrogen chloride (HCl);
(ii) passing the gas stream G1 into a reaction zone Z, bringing the gas stream G1 into contact with a catalyst comprised in said reaction zone Z, obtaining a gas stream GP comprising chlorine (Cl₂) and one or more of O₂, H₂O and HCl, and removing the gas stream GP from said reaction zone Z;
(iii) dividing the gas stream GP, obtaining two gas streams, being a gas stream G2 and a gas stream GR, G2 and GR having the same chemical composition as GP, wherein the ratio of the mass flow f(GR) of the gas stream GR relative to the mass flow f(G2) of the gas stream G2, f(GR):f(G2), is in the range of from 0.1:1 to 20:1;
   wherein during standard operation mode of the continuous process, providing the gas stream G1 according to (i) comprises
   preparing G1 as a mixture comprising at least two gas streams, said at least two gas streams comprising the gas stream GR and j gas streams G0(k) with k=1, . . . j, wherein the j gas streams G0(k) in total comprise oxygen (O₂) and hydrogen chloride (HCl) and wherein j is in the range of from 1 to 3.

In the context of the present invention, it is preferred that the reaction zone Z comprises a reactor comprising a catalyst.

Preferably the gas stream temperature in the reactor is of at most 450° C., more preferably of at most 400° C., the temperature being preferably measured with a thermocouple. Any thermocouple well-known in the art can be used for such measurement.

It is preferred that the reactor is an adiabatic fixed-bed reactor. Preferably the adiabatic fixed-bed reactor comprises one catalyst bed comprising a catalyst. Alternatively, it is preferred that the adiabatic fixed-bed reactor is a multi-stage reactor comprising two or more catalyst beds, wherein each of the two or more catalyst beds comprises a catalyst, wherein the catalyst in the respective catalyst beds has the same or different chemical compositions. The catalysts used in such multistage reactor may preferably also show different catalytic activities.

It is preferred that the process further comprises, after (iii), passing the gas stream GR through a return means R prior to preparing G1 according to (i), during standard operation mode of the continuous process, in an ejector.

Preferably the return means R forms a loop external to the reactor, for recycling GR and passing it into the ejector for admixing with the j gas streams G0(k) according to (i), during standard operation mode of the continuous process.

It is preferred that the catalyst comprised in the reaction zone Z is selected from the group consisting of a Ru-based catalyst, a Ce-based catalyst, a Cu-based catalyst and a mixture of two or more thereof, more preferably is selected from the group consisting of a Ru-based catalyst, a Ce-based catalyst and a Cu-based catalyst, more preferably is a Ru-based catalyst. Such catalysts are well described in the prior art. In particular, preferred Ru-based catalysts can be those disclosed in WO 2011/111351 A1 or WO 2007/134771 A1, preferred Ce-based catalysts can those disclosed in WO 2013/004651 A1 and WO 2013/060628 A1 and preferred Cu-based catalysts can be those disclosed in U.S. Pat. No. 2,418,930 A.

The catalyst comprised in the reaction zone Z preferably has a spherical shape or cylindrical shape or ring shape. It is also conceivable that any other shape might be used for the catalyst used in the present invention.

Preferably the catalyst comprised in the reaction zone Z has an average particle size in the range in the range of from 1 to 20 mm, more preferably in the range of from 1.5 to 15 mm, more preferably in the range of from 2 to 10 mm.

Preferably the catalyst is a Ru-based catalyst, wherein said catalyst comprises Ru supported on an oxidic support material.

Preferably from 20 to 100 weight-%, more preferably from 30 to 80 weight-%, more preferably from 40 to 70 weight-%, of the gas stream GP consist of chlorine.

The present invention further relates to a production unit for carrying out the process according to the present invention, the unit comprising
a reaction zone Z comprising
   an inlet means for passing the gas stream G1 into Z;
   a catalyst;
   a reaction means for bringing into contact the gas stream G1 with said catalyst;
   an outlet means for removing the gas stream GP from Z;
a stream dividing device S for dividing the gas stream GP in at least two streams, more preferably two streams, comprising a gas stream GR and a gas stream G2;
a means for passing the gas stream GP into said device S;
a means M for preparing G1 as a mixture comprising GR and j gas streams G0(k) with k=1, . . . j, wherein j is in the range of from 1 to 3, more preferably 1 or 2, more preferably 2;
a return means R for passing the gas stream GR exiting from S to said means M for preparing G1.

Preferably the reaction means of the reaction zone Z is a reactor.

Preferably the reaction means of the reaction zone Z is an adiabatic fixed bed reactor. Preferably the adiabatic fixed-bed reactor comprises one catalyst bed comprising a catalyst. Alternatively, it is preferred that the adiabatic fixed-bed reactor is a multi-stage reactor comprising two or more catalyst beds, wherein each of the two or more catalyst beds comprises a catalyst, wherein the catalyst in the respective catalyst beds has the same or different chemical compositions. The catalysts used in such multistage reactor may preferably also exhibit different catalytic activities.

It is preferred that the reactor have an inner diameter in the range of from 1.0 m to 10.0 m, more preferably in the range of from 2.0 m to 7.0 m, more preferably in the range of from 3.0 m to 6.0 m.

Preferably the reactor have a wall thickness in the range of from 10 mm to 50 mm, more preferably in the range of from 15 to 35 mm.

Preferably the reactor are made of corrosion-resistant material, more preferably of iron-based alloys, nickel-based alloys, nickel or nickel clad, more preferably of nickel or nickel clad. Nickel clad is preferably made with 2 to 5 mm with nickel.

It is preferred that all elements of the reactor be made of nickel-containing material.

It is preferred that the production unit further comprises, downstream of the reaction zone Z and upstream of the stream dividing device S, a heat exchanger, wherein the gas stream GP is passed through. This is for example illustrated by FIG. 1.

Preferably the return means R further comprises a heat exchanger for cooling GR prior to enter the means M. This is for example illustrated by FIG. 3.

Preferably the heat exchanger used in the present invention is a tube bundle heat exchanger, wherein the heat exchanger is more preferably made of corrosion-resistant material, more preferably of nickel-based material, such as nickel clad, or nickel.

It is preferred that the return means R is a return pipe, more preferably an external return pipe to the reactor of Z or an internal return pipe to the reactor of Z, more preferably an external return pipe. This is for example illustrated by FIGS. 1-3.

Preferably the return pipe has an inner diameter of at most 2000 mm, more preferably in the range of from 100 to 2000 mm, more preferably in the range of from 150 to 1000 mm.

Preferably the return pipe is made of corrosion-resistant material, more preferably of iron-based alloys, nickel-based alloys, nickel or nickel clad, more preferably of nickel-based alloys, nickel or nickel clad.

It is preferred that the production unit further comprises one or more pipes, wherein the pipes are made of corrosion-resistant material, more preferably of iron-based alloys, nickel-based alloys, nickel or nickel clad, more preferably of nickel-based alloys, nickel or nickel clad. It is also conceivable that the pipes are preferably made of tantalum-based material, when positioned downstream of the heat exchanger.

It is preferred that the production unit comprises a pipe for the liquid stream L, wherein said pipe is made of silicon carbide.

It is preferred that the means M is a mixing device, wherein the mixing device is an ejector, a static mixer or a dynamic mixer, more preferably an ejector.

The present invention further relates to a use of a production unit according to the present invention for the continuous production of chlorine.

The present invention further relates to a process for preparing phosgene comprising preparing chlorine according to the process of the present invention;
reacting the obtained chlorine with carbon monoxide in the presence of a catalyst, in gas phase, obtaining phosgene.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. A continuous process for preparing chlorine, comprising
   (i) providing a gas stream G1 comprising oxygen (O₂) and hydrogen chloride (HCl);
   (ii) passing the gas stream G1 into a reaction zone Z, bringing the gas stream G1 into contact with a catalyst comprised in said reaction zone Z, obtaining a gas stream GP comprising chlorine (Cl2) and one or more of O₂, H₂O and HCl, and removing the gas stream GP from said reaction zone Z;
   (iii) dividing the gas stream GP, obtaining at least two gas streams comprising a gas stream G2 and a gas stream GR, G2 and GR having the same chemical composition as GP, wherein the ratio of the mass flow f(GR) of the gas stream GR relative to the mass flow f(G2) of the gas stream G2, f(GR):f(G2), is in the range of from 0.1:1 to 20:1;
   wherein during standard operation mode of the continuous process, providing the gas stream G1 according to (i) comprises
   preparing G1 as a mixture comprising at least two gas streams, said at least two gas streams comprising the gas stream GR and j gas streams G0(k) with k=1, . . . j, wherein the j gas streams G0(k) in total comprise oxygen (O₂) and hydrogen chloride (HCl) and wherein j is in the range of from 1 to 3.
2. The process of embodiment 1, wherein j is 1 or 2, preferably 2.
3. The process of embodiment 1 or 2, wherein the reaction zone Z is an adiabatic reaction zone.
4. The process of embodiment 1 or 2, wherein f(GR):f(G2) is in the range of from 1:1 to 10:1, preferably in the range of from 2:1 to 8:1, more preferably in the range of from 2.5:1 to 6:1, more preferably in the range of from 3:1 to 5:1, more preferably in the range of from 3.2:1 to 5:1, more preferably in the range of from 3.4:1 to 5:1.
5. The process of any one of embodiments 1 to 4, wherein the mole ratio of the amount of oxygen, in mol, to the amount of hydrogen chloride, in mol, in the j gas streams G0(k) is in the range of from 0.1:1 to 2:1, preferably in the range of 0.15:1 to 0.8:1, more preferably in the range of from 0.2:1 to 0.7:1, more preferably in the range of from 0.3:1 to 0.6:1.
6. The process of any one of embodiments 1 to 5, wherein during standard operation mode of the continuous process, providing the gas stream G1 according to (i) comprises preparing G1 as a mixture comprising, more preferably consisting of, three gas streams, said three gas streams comprising the gas stream GR and two gas streams G0(1) and G0(2), wherein the two gas streams G0(1) and G0(2) in total comprise oxygen (O₂) and hydrogen chloride (HCl).
7. The process of any one of embodiments 1 to 6, wherein during standard operation mode of the continuous process, providing the gas stream G1 according to (i) comprises preparing G1, as a mixture comprising, more preferably consisting of, three gas streams GR, G0(1) and G0(2), G0(1) comprising oxygen (O₂) and G0(2) comprises hydrogen chloride (HCl), which comprises
   combining the gas stream G0(1) with the gas stream G0(2), preferably in a static mixer, and
admixing the gas stream GR with the combined gas streams G0(1) and G0(2).
8. The process of embodiment 7, wherein admixing the gas stream GR with the combined two gas streams G0(1) and G0(2) according to (i) is performed in a mixing device, wherein the mixing device is an ejector, a static mixer or a dynamic mixer, preferably an ejector, wherein the ejector is more preferably driven by the combined gas streams G0(1) and G0(2).
9. The process of embodiment 7 or 8, wherein the combined gas streams G0(1) and G0(2) have a pressure P0 and the gas stream GR has a pressure PR, wherein P0>PR, wherein preferably the gas stream G1 has a pressure P1 and P0>P1>PR; wherein more preferably the pressure P0 ranges from 2 to 50 bar(abs), preferably from 4 to 20 bar(abs).
10. The process of any one of embodiments 6 to 9, wherein the mole ratio of the amount of oxygen, in mol, to the amount of hydrogen chloride, in mol, in the combined gas streams G0(1) and G0(2) is in the range of from 0.1:1 to 2:1, preferably in the range of 0.15:1 to 0.8:1, preferably in the range of from 0.2:1 to 0.7:1, more preferably in the range of from 0.3:1 to 0.6:1.
11. The process of any one of embodiments 1 to 10, wherein the recycle ratio is the ratio of the mass flow f(GR) of the gas stream GR relative to the mass flow f(GP) of the gas stream GP, f(GR):f(GP), which is in the range of from 0.2:1 to 0.95:1, preferably in the range of from 0.5:1 to 0.9:1, more preferably in the range of from 0.7:1 to 0.85:1.
12. The process of any one of embodiments 1 to 11, wherein the gas stream GP has a temperature T(GP) of at most 450° C., preferably of at most 400° C., wherein said temperature T(GP) is preferably controlled by fixing the recycle ratio defined in embodiment 11 and by varying the temperature of the gas stream G1.
13. The process of any one of embodiments 1 to 12, wherein the gas stream G1 has a temperature T(G1) of at least 200° C., preferably at least 250° C., more preferably in the range of from 250° C. to 300° C.
14. The process of any one of embodiments 1 to 13, wherein (ii) further comprises passing the gas stream GP removed from the reaction zone Z in a heat exchanger, obtaining a cooled gas stream GP, preferably having a temperature in the range of from 200 to 350° C., more preferably in the range of from 250 to 300° C., wherein the heat exchanger preferably is a tube bundle heat exchanger.
15. The process of any one of embodiments 1 to 13, wherein (iii) further comprising passing the gas stream GR in a heat exchanger, obtaining a cooled gas stream GR, preferably having a temperature in the range of from 200 to 350° C., more preferably in the range of from 250 to 300° C., prior to admixing with G0 in (i.2) during standard operation mode of the continuous process, wherein the heat exchanger preferably is a tube bundle heat exchanger.
16. The process of embodiment 15, wherein (iii) further comprising passing the gas stream G2 in a heat exchanger, obtaining a cooled gas stream G2, preferably having a temperature in the range of from 200 to 350° C., more preferably in the range of from 250 to 300° C., wherein the heat exchanger preferably is a tube bundle heat exchanger.
17. The process of any one of embodiments 14 to 16, wherein the gas stream G0(k) has a temperature T(G0(k)) in the range of from 200 to 350° C., more preferably in the range of from 250 to 300° ° C.,
   wherein preferably, as far as embodiment 17 depends on embodiment 7, the gas stream G0(1) has a temperature T(G0(1)) in the range of from 200 to 350° ° C., more preferably in the range of from 250 to 300° C., and the gas stream G0(2) has a temperature T(G0(2)) in the range of from 200 to 350° C., more preferably in the range of from 250 to 300° C.
18. The process of any one of embodiments 1 to 5, wherein during standard operation mode of the continuous process, providing the gas stream G1 according to (i) comprises preparing G1 as a mixture comprising, more preferably consisting of, a liquid stream L and three gas streams comprising the gas stream GR and two gas streams G0(1) and G0(2), wherein the two gas streams G0(1) and G0(2) in total comprise oxygen (O₂) and hydrogen chloride (HCl), wherein the liquid stream L comprises hydrogen chloride (HCl) and water.
19. The process of any one of embodiments 1 to 5 and 18, wherein during standard operation mode of the continuous process, providing the gas stream G1 according to (i) comprises preparing G1, as a mixture comprising, more preferably consisting of, a liquid stream L and three gas streams GR, G0(1) and G0(2), G0(1) comprising oxygen (O₂) and G0(2) comprises hydrogen chloride (HCl), wherein the liquid stream L comprises hydrogen chloride (HCl) and water, which comprises
   combining the gas stream G0(1) with the gas stream G0(2), preferably in a static mixer, and
   admixing the gas stream GR with the combined gas streams G0(1) and G0(2) and the liquid stream L.
20. The process of embodiment 19, wherein admixing the gas stream GR with the combined two gas streams G0(1) and G0(2) and the liquid stream L according to (i) is performed in a mixing device, wherein the mixing device is an ejector, a static mixer or a dynamic mixer, preferably an ejector, wherein the ejector is more preferably driven by the combined gas streams G0(1) and G0(2).
21. The process of any one of embodiments 1 to 5 and 18, wherein during standard operation mode of the continuous process, providing the gas stream G1 according to (i) comprises preparing G1, as a mixture comprising, more preferably consisting of, a liquid stream L and three gas streams GR, G0(1) and G0(2), G0(1) comprising oxygen (O₂) and G0(2) comprises hydrogen chloride (HCl), wherein the liquid stream L comprises hydrogen chloride (HCl) and water, which comprises
   combining the gas stream G0(1) with the gas stream G0(2), preferably in a static mixer,
   admixing the gas stream GR with the combined gas streams G0(1) and G0(2), and
   subsequently adding the liquid stream L to the admixed gas streams.
22. The process of embodiment 21, wherein admixing the gas stream GR with the combined two gas streams G0(1) and G0(2) according to (i) is performed in a mixing device, wherein the mixing device is an ejector, a static mixer or a dynamic mixer, preferably an ejector, wherein the ejector is more preferably driven by the combined gas streams G0(1) and G0(2).
23. The process of any one of embodiments 18 to 22, wherein the liquid stream L has temperature T(L) in the range of from 10 to 60° C., preferably in the range of from 15 to 30° C., wherein the liquid stream L preferably consists of HCl and water.
24. The process of any one of embodiments 18 to 23, wherein from 10 to 60 weight-%, preferably from 20 to 50 weight-%, more preferably from 20 to 40 weight-%, of the liquid stream L consists of HCl.
25. The process of any one of embodiments 18 to 24, wherein from 98 to 100 weight-%, preferably from 99 to 100 weight-%, more preferably from 99.5 to 100 weight-%, of the liquid stream L consists of water and HCl.
26. The process of any one of embodiments 18 to 25, wherein during standard operation mode of the continuous process,
   providing G1 according to (i) further comprises
   passing the combined gas streams G0(1) and G0(2) in a heat exchanger, obtaining a cooled gas stream G0, preferably having a temperature in the range of from 10 to 60° C., preferably in the range of from 15 to 30° C.
27. The process of any one of embodiments 1 to 26, wherein from 50 to 100 weight-%, preferably from 70 to 100 weight-%, more preferably from 90 to 100 weight-%, more preferably from 99 to 100 weight-%, more preferably from 99.5 to 100 weight-%, of the j gas streams G0(k) consist of HCl and O₂.
28. The process of any one of embodiments 1 to 27, wherein according to (iii), two gas streams are obtained, a gas stream G2 and a gas stream GR.
29. The process of any one of embodiments 1 to 28, wherein the reaction zone Z comprises a reactor comprising the catalyst.
30. The process of embodiment 29, wherein the gas stream in the reactor is of at most 450° C., preferably of at most 400° C., the temperature being preferably measured with a thermocouple.
31. The process of embodiment 29 or 30, wherein the reactor is an adiabatic fixed-bed reactor.
32. The process of embodiment 30,
   wherein the adiabatic fixed-bed reactor comprises one catalyst bed comprising a catalyst, or
   wherein the adiabatic fixed-bed reactor is a multi-stage reactor comprising two or more catalyst beds, wherein each of the two or more catalyst beds comprises a catalyst, wherein the catalyst in the respective catalyst beds has the same or different chemical compositions.
33. The process of any one of embodiments 1 to 32, further comprising, after (iii), passing the gas stream GR through a return means R prior to preparing G1 according to (i), during standard operation mode of the continuous process, in an ejector.
34. The process of embodiment 33, as far as it depends on any one of embodiments 28 to 30, wherein the return means R forms a loop external to the reactor, for recycling GR and passing it into the ejector for admixing with the j gas streams G0(k) according to (i), during standard operation mode of the continuous process.
35. The process of any one of embodiments 1 to 34, wherein the catalyst is selected from the group consisting of a Ru-based catalyst, a Ce-based catalyst, a Cu-based catalyst and a mixture of two or more thereof, preferably is selected from the group consisting of a Ru-based catalyst, a Ce-based catalyst and a Cu-based catalyst, more preferably is a Ru-based catalyst.
36. The process of embodiment 35, wherein the catalyst is a Ru-based catalyst, said catalyst comprising Ru supported on an oxidic support material.
37. The process of any one of embodiments 1 to 36, wherein from 20 to 100 weight-%, preferably from 30 to 80 weight-%, of the gas stream GP consist of chlorine.
38. The process of embodiment 37, wherein from 40 to 70 weight-% of the gas stream GP consist of chlorine.
39. A production unit for carrying out the process according to any one of embodiments 1 to 38, the unit comprising
   a reaction zone Z comprising
      an inlet means for passing the gas stream G1 into Z;
      a catalyst;
      a reaction means for bringing into contact the gas stream G1 with said catalyst;
      an outlet means for removing the gas stream GP from Z;
   a stream dividing device S for dividing the gas stream GP in at least two streams, preferably two streams, comprising a gas stream GR and a gas stream G2;
   a means for passing the gas stream GP into said device S;
   a means M for preparing G1 as a mixture comprising GR and j gas streams G0(k) with k=1, . . . j, wherein j is in the range of from 1 to 3, preferably 1 or 2, more preferably 2;
   a return means R for passing the gas stream GR exiting from S to said means M for preparing G1.
40. The production unit of embodiment 39, wherein the reaction means of the reaction zone Z is a reactor.
41. The production unit of embodiment 40, wherein the reaction means of the reaction zone Z is an adiabatic fixed bed reactor.
42. The production unit of any one of embodiments 39 to 41, wherein the adiabatic fixed-bed reactor comprises one catalyst bed comprising a catalyst.
43. The production unit of any one of embodiments 39 to 41, wherein the adiabatic fixed-bed reactor is a multi-stage reactor comprising two or more catalyst beds, wherein each of the two or more catalyst beds comprises a catalyst, wherein the catalyst in the respective catalyst beds has the same or different chemical compositions.
44. The production unit of any one of embodiments 40 to 43, wherein the reactor have an inner diameter in the range of from 1.0 m to 10.0 m, preferably in the range of from 2.0 m to 7.0 m, more preferably in the range of from 3.0 m to 6.0 m.
45. The production unit of any one of embodiments 40 to 44, wherein the reactor have a wall thickness in the range of from 10 mm to 50 mm, preferably in the range of from 15 to 35 mm.
46. The production unit of any one of embodiments 40 to 45, wherein the reactor are made of corrosion-resistant material, preferably of iron-based alloys, nickel-based alloys, nickel or nickel clad, more preferably of nickel or nickel clad.
47. The production unit of any one of embodiments 39 to 46, further comprising, downstream of the reaction zone Z and upstream of the stream dividing device S, a heat exchanger, wherein the gas stream GP is passed through.
48. The production unit of any one of embodiments 39 to 46, wherein the return means R further comprises a heat exchanger for cooling GR prior to enter the means M.
49. The production unit of embodiment 48, wherein the heat exchanger is a tube bundle heat exchanger, wherein the heat exchanger is preferably made of corrosion-resistant material, more preferably of nickel-based material or nickel.
50. The production unit of any one of embodiments 39 to 49, wherein the return means R is a return pipe, preferably an external return pipe to the reactor of Z or an internal return pipe to the reactor of Z, more preferably an external return pipe.
51. The production unit of embodiment 50, wherein the return pipe has an inner diameter of at most 2000 mm, preferably in the range of from 100 to 2000 mm, more preferably in the range of from 150 to 1000 mm.
52. The production unit of embodiment 50 or 51, wherein the return pipe is made of corrosion-resistant material, preferably of iron-based alloys, nickel-based alloys, nickel or nickel clad, more preferably of nickel-based alloys, nickel or nickel clad.
53. The production unit of any one of embodiments 39 to 52, wherein the means M is a mixing device, wherein the mixing device is an ejector, a static mixer or a dynamic mixer, preferably an ejector.
54. Use of a production unit according to any one of embodiments 39 to 53 for the continuous production of chlorine.
55. A process for preparing phosgene comprising preparing chlorine according to the process of any one of embodiments 1 to 38; reacting the obtained chlorine with carbon monoxide in the presence of a catalyst, in gas phase, obtaining phosgene.

In the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and B and C, or A and B and D, or B and C and D, or A and B and C and D.

The present invention is further described by the following reference examples and examples.

### EXAMPLES

### Example 1: Production of Chlorine According to the Present Invention

A feed stream of 4 kmol/h (146 kg/h) HCl and 2 kmol/h (64 kg/h) O₂ acting as the motive gas stream G0 (having a T(G0)=280)° C. in an ejector M sucks a recycle flow (gas stream GR) of 21.5 kmol/h (880 kg/h) from the adiabatic reactor outlet. The recycle ratio f(GR): f(GP) was of 0.8:1 and the ratio f(GR): f(G2) was of 4.2:1. The ejector outlet gas flow G1 is fed to the reactor at 5.4 bara. The temperature rises in the reaction zone Z by adiabatic reaction in a catalyst bed into equilibrium to 390° C.

The reactor outlet stream GP is cooled down in a heat exchanger H from 390 to 280° C. before dividing the stream into recycle gas stream GR and outlet gas stream G2. The amount of HCl in G2 related to the feed flow of 4 kmol/h of HCl in G0 gives a HCl conversion of about 88%. The production unit used for this process is illustrated in FIG. 1.

### Comparative Example 1: Production of Chlorine Not According to the Present Invention

The process of Example 1 was repeated except that no recycling has been performed. In particular, a feed stream G0 of 4 kmol/h HCl and 2 kmol/h O₂ is fed in an adiabatic reactor at 5.4 bara. The temperature rises in the reaction zone Z by adiabatic reaction in a catalyst bed into equilibrium to 665° C., wherein the catalyst bed is the same as the one used in Example 1. This high temperature at the outlet of the catalyst bed leads to corrosion of the production unit (reactor and pipes) and destruction/deactivation of the catalyst.

The amount of HCl in the gas stream GP exiting the reaction zone related to the feed flow of 4 kmol/h gives a HCl conversion of about 61.5%. The production unit used for this process is illustrated in FIG. 4.

### Example 2: Production of Chlorine According to the Present Invention

A feed stream of 3.88 kmol/h (141.4 kg/h) gaseous HCl, 2 kmol/h (64 kg/h) of gaseous O₂ acting as the motive gas stream G0 (having a T(G0)=20° C.) in an ejector M, with a liquid stream L (having a T(L)=20° C.) of 14.74 kg/h aqueous HCl (30 wt.-% HCl in water), sucks a recycle flow (gas stream GR) of 20.26 kmol/h (780.9 kg/h) from the adiabatic reactor outlet. The recycle ratio f(GR):f(GP) was of 0.78:1 and the ratio f(GR):f(G2) was of 3.54:1. The ejector outlet gas flow G1 is fed to the reactor at 5.4 bara. The temperature rises in the reaction zone Z by adiabatic reaction in a catalyst bed into equilibrium to 390° C.

The reactor outlet stream GP is divided into recycle gas stream GR and outlet gas stream G2. The amount of HCl in G2 related to the feed flow of 4 kmol/h gives a HCl conversion of about 86.1%. The production unit used for this process is illustrated in FIG. 2.

### Comparative Example 2: Production of Chlorine Not According to the Present Invention

Same feed conditions like in Example 1 were applied for the process of Comparative Example 2, but the recycle stream was reduced to fit the upper limit of f(GR):f(G2)=3:1 given by US 2004/052718. The mass flow of the recycle stream GR was thus of 15.4 kmol/h (629.5 kg/h). Reactor pressure and inlet temperature were the same with 5.4 bara and 280° C. The temperature rises in the reaction zone Z by adiabatic reaction in a catalyst bed into equilibrium to 418° C. The amount of HCl in G2 related to the feed flow of 4 kmol/h gives a HCl conversion of about 85.5% (reduced conversion compared to the process of the present invention).

Thus, by comparing Example 1 with Comparative Example 2, it is noted that the ratio of f(GR):f(G2) has an effect on the HCl conversion as well as the equilibrium temperature in the catalyst bed. Indeed, with the process of the present invention, such equilibrium temperature can be reduced, lowering the deactivation of the catalyst, and the HCl conversion is increased.

### Comparative Example 3: Production of Chlorine Not According to the Present Invention

A feed stream of 4 kmol/h HCl and 2 kmol/h O₂ acting as the motive gas stream G0 (having a T(G0)=280° C.) in an ejector M sucks a recycle flow (gas stream GR) of 16.1 kmol/h (629.5 kg/h) from the adiabatic reactor outlet according a f(GR):f(G2) ratio of 3:1 as described in US 2004/052718. The ejector outlet gas flow G1 is fed to the reactor at 5.4 bara. The temperature rises in the reaction zone Z by adiabatic reaction in a catalyst bed into equilibrium to 666° C. The reactor outlet stream GP is not cooled down in a heat exchanger H before dividing the stream into recycle gas stream GR and outlet gas stream G2 as defined in US 2004/052718. Mixing of GR and G0 leads to a mixture temperature of G1 at 571° C. The amount of HCl in G2 related to the feed flow of 4 kmol/h of HCl in G0 gives a HCl conversion of about 61.5%.

Hence, the HCl conversion is much lower than the one obtained with the process of the present invention (Example 1 or 2). Further, severe corrosion and catalyst deactivation issues are expected due to the high outlet temperature of reactor. The example shows, that adiabatic operation at a ratio f(GR).f(G2) of 3:1 as described in US 2004/052718 leads to main disadvantages compared to adiabatic operation with external heat exchanger like claimed here.

### DESCRIPTION OF THE FIGURES

FIG. 1 is a schematic representation of a production unit according to embodiments of the invention. The production unit comprises a reaction zone Z comprising an inlet means, such as a pipe, for passing the gas stream G1 into Z and a reaction means for bringing into contact the gas stream G1 with a catalyst (not shown), preferably an adiabatic reactor, namely a reactor wherein the reaction is operated adiabatically. The temperature of gas stream G1 is of 280° C. The reactor is a reactor, preferably an adiabatic fixed-bed reactor. The maximum gas stream temperature in the reactor and at the outlet of the reactor was 390° C. Further, the reaction zone Z comprises an outlet means, for example a pipe, for removing the gas stream GP from Z. The gas stream GP comprises chlorine and one or more of HCl, H₂O and O₂. The production unit further comprises a heat exchanger H for cooling the gas stream GP prior to be divided in a stream dividing device in two streams, a gas stream GR and a gas stream G2, a means, such as a pipe, for passing the gas stream GP into the stream dividing device not represented in this figure. The gas streams G2 and GR have respectively the same chemical composition as GP. The amount of HCl in G2 related to the feed flow of HCl in G0 gives a HCl conversion of about 88%. The production unit further comprises a means M, preferably an ejector driven by G0, for admixing the gas stream G0 with the gas stream GR comprising an inlet means, such as a pipe, for feeding the gas stream G0 into M and a means for feeding the gas stream GR into M. The gas stream G0 consists of HCl and O₂. To obtain G0 two gas streams, G0(1) consisting of HCl and G0(2) consisting of O₂ were combined, these streams are not shown here. The recycle gas stream GR is sucked in the ejector M. The recycle ratio is the ratio of the mass flow f(GR) of the gas stream GR relative to the mass flow f(GP) of the gas stream GP, f(GR):f(GP), which was of about 0.8:1. The production unit further comprises a return means R, a return pipe, for passing the gas stream GR exiting from the stream dividing device to said means M.
FIG. 2 is a further schematic representation of a production unit according to embodiments of the invention. The production unit comprises a reaction zone Z comprising an inlet means, such as a pipe, for passing the gas stream G1 into Z and a reaction means for bringing into contact the gas stream G1 with a catalyst C, preferably an adiabatic reactor, namely a reactor wherein the reaction is operated adiabatically. The temperature of gas stream G1 is of 280° C. The reactor is an adiabatic fixed-bed reactor. The maximum gas stream temperature in the reactor and at the outlet of the reactor was 390° C. Further, the reaction zone Z comprises an outlet means, for example a pipe, for removing the gas stream GP from Z. The gas stream GP comprises chlorine and one or more of HCl, H₂O and O₂. The production unit further comprises a stream dividing device dividing the gas stream GP in two streams, a gas stream GR and a gas stream G2, a means, such as a pipe, for passing the gas stream GP into the stream dividing device not represented in this figure. The gas streams G2 and GR have respectively the same chemical composition as GP. The amount of HCl in G2 related to the feed flow of HCl in G0 gives a HCl conversion of about 86.2%. The production unit further comprises a means M, preferably an ejector driven by G0, for admixing the gas stream G0 and a liquid stream L comprising water and HCl liquid stream L with the gas stream GR comprising two inlet means, such as a pipe, for feeding the gas stream G0 and the liquid stream L into M and a means for feeding the gas stream GR into M. The gas stream G0 consists of HCl and O₂ and has a temperature of 20° C. To obtain G0 two gas streams, G0(1) consisting of HCl and G0(2) consisting of O₂ were combined, these streams are not shown here. The liquid stream L consisting of hydrochloric acid in water (30 wt. % HCl) has also a temperature of 20° C. The recycle gas stream GR is sucked in the ejector M. The recycle ratio is the ratio of the mass flow f(GR) of the gas stream GR relative to the mass flow f(GP) of the gas stream GP, f(GR):f(GP), which was of about 0.78:1. The production unit further comprises a return means R, a return pipe, for passing the gas stream GR exiting from the stream dividing device to said means M.

FIG. 3 is a further schematic representation of a production unit according to embodiments of the invention. The production unit comprises a reaction zone Z comprising an inlet means, such as a pipe, for passing the gas stream G1 into Z and a reaction means for bringing into contact the gas stream G1 with a catalyst C, preferably an adiabatic reactor, namely a reactor wherein the reaction is operated adiabatically. The minimum temperature of G1 is of at least 200° C., preferably at least 250° C. The reactor is an adiabatic fixed bed reactor. The maximum gas stream temperature in the reactor and at the outlet of the reactor was set to at most 400° C. Further, the reaction zone Z comprises an outlet means, for example a pipe, for removing the gas stream GP from Z. The gas stream GP comprises chlorine and one or more of HCl, H₂O and O₂. The production unit further comprises a stream dividing device for dividing the gas stream GP in two streams, a gas stream GR and a gas stream G2, a means, such as a pipe, for passing the gas stream GP into the stream dividing device not represented in this figure. The gas streams G2 and GR have respectively the same chemical composition as GP. The amount of HCl in G2 related to the feed flow of HCl in G0 gives preferably a HCl conversion of from 60-100%. The production unit further comprises a means M, preferably an ejector, for admixing the gas stream G0 with the gas stream GR comprising an inlet means, such as a pipe, for feeding the gas stream G0 into M and a means for feeding the gas stream GR into M. The gas stream G0 consists of HCl and O₂. To obtain G0 two gas streams, G0(1) consisting of HCl and G0(2) consisting of O₂ were combined, these streams are not shown here. The recycle gas stream GR is passed through a heat exchanger H prior to being sucked in the ejector M. The recycle ratio is the ratio of the mass flow f(GR) of the gas stream GR relative to the mass flow f(GP) of the gas stream GP, f(GR):f(GP), which is in the range of from 0.2:1 to 0.95:1, preferably in the range of from 0.5:1 to 0.9:1, more preferably in the range of from 0.7:1 to 0.85:1. The production unit further comprises a return means R, a return pipe, for passing the gas stream GR exiting from the stream dividing device to heat exchanger H and from heat exchanger H to said means M.

FIG. 4 is a further schematic representation of a production unit used in Comparative Example 1 (not according to the invention). The production unit comprises a reaction zone Z comprising an inlet means, such as a pipe, for passing the gas stream G0 into Z and a reaction means for bringing into contact the gas stream G0 with a catalyst (not shown), preferably an adiabatic reactor, namely a reactor wherein the reaction is operated adiabatically. The temperature of gas stream G0 is of 280° C. The reactor is an adiabatic fixed-bed reactor. The maximum gas stream temperature in the reactor and at the outlet of the reactor was 665° C. Further, the reaction zone Z comprises an outlet means, for example a pipe, for removing the gas stream GP from Z. The gas stream GP comprises chlorine and one or more of HCl, H₂O and O₂. The production unit further comprises a heat exchanger H for cooling the gas stream GP. The amount of HCl in GP related to the feed flow of HCl in G0 gives a HCl conversion of about 61.5%.

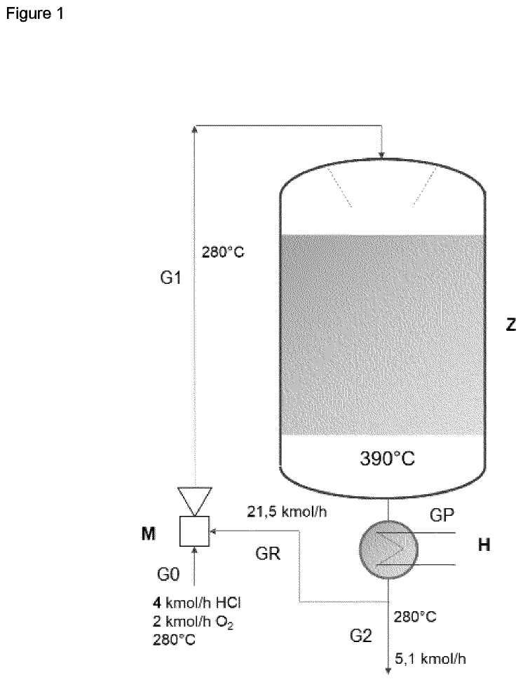

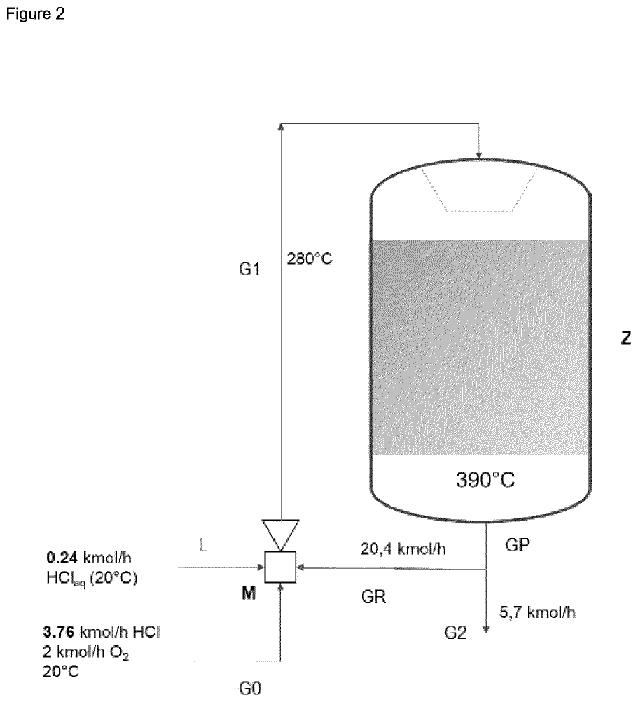

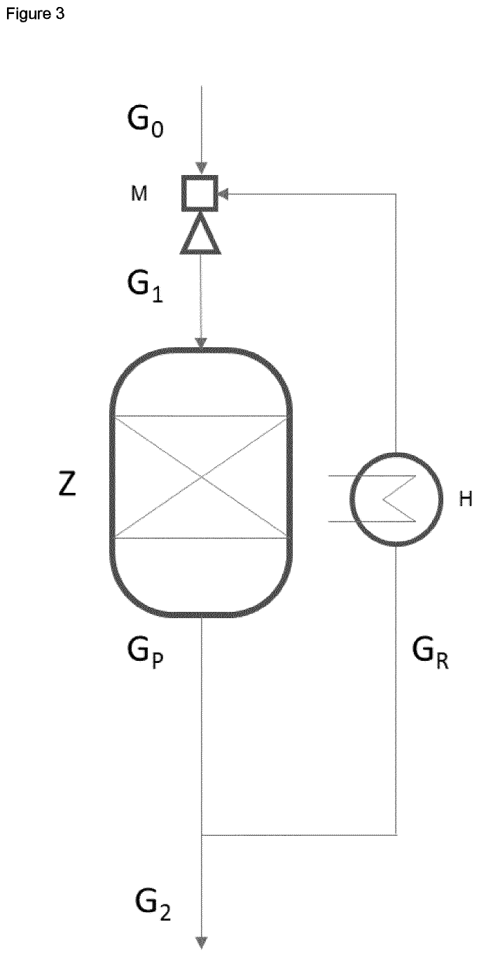

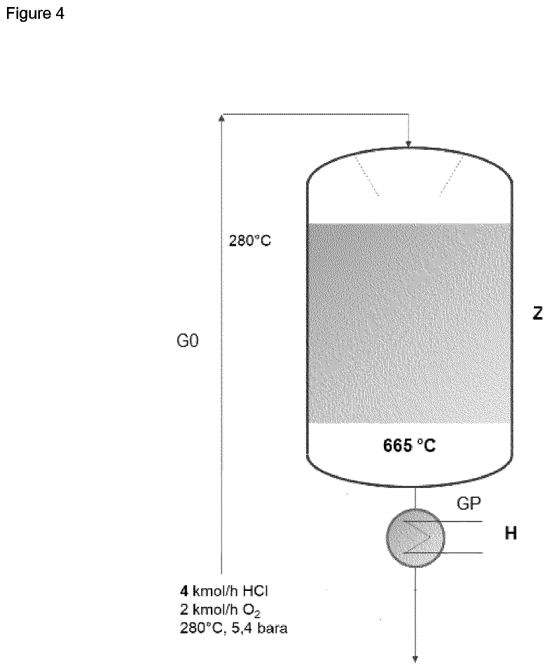

### Cited Literature

WO2007/134771 A1
WO2011/111351 A1
WO2013/004651 A1
WO 2013/060628 A1
U.S. Pat. No. 2,418,930 A
US 2004/052718

1-17. (canceled)

18. A continuous process for preparing chlorine, comprising
(i) providing a gas stream G1 comprising oxygen (O₂) and hydrogen chloride (HCl);
(ii) passing the gas stream G1 into a reaction zone Z, bringing the gas stream G1 into contact with a catalyst comprised in said reaction zone Z, obtaining a gas stream GP comprising chlorine (Cl2) and one or more of O₂, H₂O and HCl, and removing the gas stream GP from said reaction zone Z;
(iii) dividing the gas stream GP, obtaining at least two gas streams comprising a gas stream G2 and a gas stream GR, G2 and GR having the same chemical composition as GP, wherein the ratio of the mass flow f(GR) of the gas stream GR relative to the mass flow f(G2) of the gas stream G2, f(GR):f(G2), is in the range of from 0.1:1 to 20:1;
wherein during standard operation mode of the continuous process, providing the gas stream G1 according to (i) comprises
preparing G1 as a mixture comprising at least two gas streams, said at least two gas streams comprising the gas stream GR and j gas streams G0(k) with k=1, . . . j, wherein the j gas streams G0(k) in total comprise oxygen (O₂) and hydrogen chloride (HCl) and wherein j is in the range of from 1 to 3.

19. The process of claim 18, wherein j is 1 or 2.

20. The process of claim 18, wherein the reaction zone Z is an adiabatic reaction zone.

21. The process of claim 18, wherein f(GR):f(G2) is in the range of from 1:1 to 10:1.

22. The process of claim 21, wherein f(GR):f(G2) is in the range of from 3.2:1 to 5:1.

23. The process of claim 18, wherein during standard operation mode of the continuous process, providing the gas stream G1 according to (i) comprises preparing G1, as a mixture comprising three gas streams GR, G0(1) and G0(2), G0(1) comprising oxygen (O₂) and G0(2) comprises hydrogen chloride (HCl), which comprises
combining the gas stream G0(1) with the gas stream G0(2), and
admixing the gas stream GR with the combined gas streams G0(1) and G0(2).

24. The process of claim 23, wherein, according to (i), admixing the gas stream GR with the combined two gas streams G0(1) and G0(2) is performed in a mixing device, wherein the mixing device is an ejector, a static mixer or a dynamic mixer.

25. The process of claim 23, wherein the combined gas streams G0(1) and G0(2) have a pressure P0 and the gas stream GR has a pressure PR, wherein P0>PR.

26. The process of claim 18, wherein the recycle ratio is the ratio of the mass flow f(GR) of the gas stream GR relative to the mass flow f(GP) of the gas stream GP, f(GR):f(GP), which is in the range of from 0.2:1 to 0.95:1;
wherein the gas stream GP has a temperature T(GP) of at most 450° C.

27. The process of claim 18, wherein (ii) further comprises passing the gas stream GP removed from the reaction zone Z in a heat exchanger, obtaining a cooled gas stream GP having a temperature in the range of from 200 to 350° C.

28. The process of claim 27, wherein f(GR):f(G2) is in the range of from 3.2:1 to 5:1.

29. The process of claim 18, wherein during standard operation mode of the continuous process, providing the gas stream G1 according to (i) comprises preparing G1, as a mixture comprising a liquid stream L and three gas streams GR, G0(1) and G0(2), G0(1) comprising oxygen (O₂) and G0(2) comprises hydrogen chloride (HCl), wherein the liquid stream L comprises hydrogen chloride (HCl) and water, which comprises
combining the gas stream G0(1) with the gas stream G0(2) and
admixing the gas stream GR with the combined gas streams G0(1) and G0(2) and the liquid stream L; or
wherein during standard operation mode of the continuous process, providing the gas stream G1 according to (i) comprises
preparing G1, as a mixture comprising a liquid stream L and three gas streams GR, G0(1) and G0(2), G0(1) comprising oxygen (O₂) and G0(2) comprises hydrogen chloride (HCl), wherein the liquid stream L comprises hydrogen chloride (HCl) and water, which comprises
combining the gas stream G0(1) with the gas stream G0(2),
admixing the gas stream GR with the combined gas streams G0(1) and G0(2), and
subsequently adding the liquid stream L to the admixed gas streams.

30. The process of claim 29, wherein the liquid stream L has temperature T(L) in the range of from 10 to 60° C.

31. The process of claim 18, further comprising, after (iii), passing the gas stream GR through a return means R prior to preparing G1 according to (i), during standard operation mode of the continuous process, in an ejector.

32. The process of claim 18, wherein the catalyst is selected from the group consisting of a Ru-based catalyst, a Ce-based catalyst, a Cu-based catalyst and a mixture of two or more thereof.

33. A production unit for carrying out the process according to claim 18, the unit comprising
a reaction zone Z comprising
an inlet means for passing the gas stream G1 into Z;
a catalyst;
a reaction means for bringing into contact the gas stream G1 with said catalyst;
an outlet means for removing the gas stream GP from Z;
a stream dividing device S for dividing the gas stream GP in at least two streams comprising a gas stream GR and a gas stream G2;
a means for passing the gas stream GP into said device S;
a means M for preparing G1 as a mixture comprising GR and j gas streams G0(k) with k=1, . . . j, wherein j is in the range of from 1 to 3;
a return means R for passing the gas stream GR exiting from S to said means M for preparing G1.

34. A process for preparing phosgene comprising preparing chlorine according to the process of claim 18;
reacting the obtained chlorine with carbon monoxide in the presence of a catalyst, in gas phase, obtaining phosgene.
